(19) United States
(12) Patent Application Publication
(10) Pub. No.: US 2008/0175959 A1
(43) Pub. Date: Jul. 24, 2008

(54) Microwavable Food Product and a Susceptor Therefor

(75) Inventors: Rodney Hill, Omaha, NE (US); Richard Charpentier, San Antonio, TX (US); Bradley Erickson Heath, Bellevue, NE (US); Melissa Kay Patterson, Omaha, NE (US)

Correspondence Address: Merchant & Gould - ConAgra, P.O. Box 2903, Minneapolis, MN, 55402, US

(73) Assignee: CONAGRA FOODS, INC., Omaha, NE (US)

(21) Appl. No.: 12/017,149

(22) Filed: Jan. 21, 2008

Related U.S. Application Data
(60) Provisional application No. 60/881,609, filed on Jan. 22, 2007.

(51) Int. Cl. B65D 81/34; A23P 1/08

(52) U.S. Cl. 426/90; 426/107; 426/394

(57) ABSTRACT

A microwavable food product includes a susceptor and a foodstuff. The foodstuff is positioned on the susceptor in an open-faced configuration. The susceptor includes at least one fold positioned at an intermediate region of the foodstuff for allowing the foodstuff to be folded from the open-faced configuration to a closed-faced configuration.

### RELATED APPLICATIONS

This application claims priority from U.S. Provisional Patent Application Ser. No. 60/881,609 filed on Jan. 22, 2007 and is hereby incorporated by reference in its entirety.

### TECHNICAL FIELD

The present disclosure generally relates to the field of microwavable food products having a susceptor.

### BACKGROUND

Susceptors are often utilized to cook food in microwaves. A susceptor is a thin, flexible sheet including layers of metal, plastic, and/or other materials, such as adhesives. For example, a metalized plastic film is laminated to a dimensionally stable substrate (i.e., plastic or paperboard) by utilizing a conventional adhesive. The metalized plastic film includes a layer of plastic film which is deposited on a layer of metal. Patterns may be embedded into the metalized film to control and/or increase its effectiveness. Several variation of susceptors exist, such as susceptors that utilize dielectric foam silicate substrates; semi-liquid glossy materials that include glycerine, sucrose ester, and chloride salt; multiple plastic layers; and edible adhesives. When heated in a microwave, the susceptor becomes a non-stick heating surface, much like a hot plate. The metalized plastic film controls the microwave conductivity and converts some of the microwave's energy into heat, which is transmitted to the surface portion of the susceptor that the food product is positioned upon, causing browning and/or crisping of the food product.

Convenience, flavor, and health content are all major factors for consumers in the purchase of food products today. Grilled and/or toasted foods are perceived by consumers as healthier than fried foods or foods that utilize oil or butter for cooking. However, consumers like the appearance and texture of fried foods. It is typically perceived as healthier to cook foods in the microwave without adding oil or butter. However, deficiencies in the prior art have prevented typical microwavable food products from coming close to the quality of baked, fried, grilled, toasted, and/or other types of cooked, folded food products, such as sandwiches.

To gain the consumer desired appearance of grilling and/or toasting in the microwave several methods have been attempted. However, past attempts to create grill marks or browning patterns generated very inconsistent results. To create desired patterns or shapes in the browning of the food products, such as grill marks, the past techniques utilized different patterns on the susceptors. The utilization of patterned susceptors to create desired browning patterns is inconsistent. For instance, the desired browning patterns were achieved less than 50% of the time.

In addition to the problem of creating a consistent simulated grilled and/or toasted look for food products, such as sandwiches, other challenges exist for food products when cooked in a microwave. For instance, one of the major shortcomings for cooking a food product in the microwave, such as a sandwich, which may include exterior and/or external foodstuffs and interior and/or internal foodstuffs, is the amount of time needed to heat the food product all the way through without causing the external foodstuff to become hard, tough, and/or dry. Conversely, if less cooking time is used, then cold spots are often present in the internal foodstuffs, which may include cheeses, meats, vegetables, bread product, omelet product, fruits, condiments, eggs, and/or other food product ingredients. Therefore, it would be desirable to provide a microwavable food product capable of consistently simulating a grilled and/or toasted product.

### SUMMARY

Accordingly, the present disclosure is directed to a microwavable food product that can be folded and that may appear to be grilled and/or toasted, such as a sandwich. Folded food products of the present disclosure may include sandwiches, omelets, hash browns, crepes, burritos, waffles, pitas, and pancakes. The present disclosure utilizes a serrated susceptor to cook and form a folded food product, such as a sandwich, that may appear to be grilled and/or toasted. While susceptors are often utilized in different variations to cook different types of microwavable food, the susceptor in the present disclosure is designed to allow the susceptor to be utilized after cooking for another purpose. The susceptor includes a serration, so the susceptor may be utilized for folding food products together after cooking. In one example, the susceptor may be serrated in two spots. In this manner, the susceptor allows the folded food product to be cooked open faced, eliminating some of the time which would otherwise be needed to cook a folded food product. Thus, the present disclosure provides the consumer with an easy, clean, and safe way to fold the cooked, hot, open faced halves of a folded food product together. Moreover, in one example, browning agents may be applied to the external foodstuff of the folded food product to consistently give the external foodstuff a desired grilled and/or toasted pattern and/or appearance after the external foodstuff is cooked on the susceptor.

It is to be understood that both the foregoing general description and the following detailed description are exemplary and explanatory only and are not necessarily restrictive of the claimed subject matter. The accompanying drawings, which are incorporated in and constitute a part of the specification, illustrate exemplary features of the disclosure and together with the general description, serve to explain the principles of the disclosure.

### BRIEF DESCRIPTION OF THE DRAWINGS

FIG. 1 is an isometric view of a microwavable food product having exemplary features of aspects in accordance with the principles of the present disclosure.

FIG. 2 is an isometric view of the microwavable food product illustrated in FIG. 1, wherein the package is opened in preparation for cooking.

FIG. 3 is an exploded view of the microwavable food product illustrated in FIG. 2, wherein the package is in an elevated position configuration.

FIG. 4 is an isometric view of the microwavable food product, wherein the exterior and interior foodstuffs are in an open-faced configuration and the package is in an elevated position configuration for supporting exterior and interior foodstuffs.

FIG. 5 is an isometric view of the microwavable food product illustrated in FIG. 4, wherein a serrated susceptor is utilized for folding.

FIG. 6 is an isometric view of the microwavable food product illustrated in FIG. 5, wherein the serrated susceptor is further along in the folding process such that the exterior and interior foodstuffs are in a closed-face configuration.

FIG. 7 is an isometric view of the microwavable food product illustrated in FIG. 4, wherein a microwave is utilized to cook the microwavable food product.

FIG. 8 is an isometric view illustrating a cooked microwavable food product, wherein a browning agent is utilized to create the appearance of grill marks.

FIG. 9 is an isometric view of a microwavable food product illustrating a package in a recessed package configuration.

FIG. 10 is an isometric view of a microwavable food product illustrating a package in a folded recessed package configuration.

FIG. 11 is an isometric view of a microwavable food product illustrating a plastic bag including a susceptor.

FIG. 12 is an isometric view of a microwavable food product illustrating a serration on an exterior foodstuff.

FIG. 13 is an isometric view of a microwavable food product illustrating one continuous piece of hash browns.

FIG. 14 is an isometric view of a microwavable food product illustrating two separate pieces of hash browns.

FIG. 15 is an isometric view of a microwavable food product illustrating one continuous piece of an omelet product.

FIG. 16 is an isometric view of a microwavable food product illustrating a piece of a bread product and piece of hash browns.

FIG. 17 is an isometric view of a microwavable food product illustrating one continuous piece of a pancake.

FIG. 18 is an isometric view of a microwavable food product illustrating two separate pancakes.

FIG. 19 is an isometric view of a microwavable food product illustrating two separate waffles.

FIG. 20 is an isometric view of a microwavable food product illustrating one continuous piece of a crepe.

FIG. 21 is an isometric view of a microwavable food product illustrating one continuous piece of a pita.

FIG. 22 is a diagram illustrating a method for providing the microwavable food product of FIG. 1.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

The present disclosure relates to a folded microwavable food product and a method of producing such a product. The microwavable food product of the present disclosure may include sandwiches, omelets, potatoes (i.e., hash browns), crepes, pitas, burritos, tacos, French toast, waffles, pancakes, etc. It is understood that other folded food products may be utilized without departing from the scope and spirit of the present disclosure. For example, a folded food product is any food product with at least two sides of an interior foodstuff adjacent to at least two sides of an exterior foodstuff or with interior foodstuffs fully or partially surrounded and/or encapsulated by an exterior foodstuff, such as an omelet or a crepe. The exterior foodstuff may include at least one of eggs, omelet product, vegetables, bread products, pancakes, waffles, French toast, tortillas, pitas, meat, and other suitable folded food product ingredients. The exterior foodstuff may be in one continuous piece or in more than one piece. The interior foodstuff may include at least one of meats, bread products, cheeses, vegetables, fruits, condiments, eggs, omelet product, and other suitable folded food product ingredients. The interior foodstuff may be in one piece, in multiple pieces, in a mixture with different types of food, and/or partially embedded in the exterior foodstuff.

A serrated susceptor is utilized to cook the food product and to fold the food product after cooking. A serrated susceptor is a susceptor having at least one serration. The serrated susceptor provides a safe surface for a consumer to touch immediately after cooking and may be utilized as a plate for on-the-go eating.

In one example, browning agents may be applied to the folded food product to produce a grilled, toasted, and/or golden brown appearance. The grilled and/or toasted appearance of the browning agent of the present disclosure creates the desired browning appearance more consistently than previous browning methods that utilized different patterns on susceptors to create desired browning patterns.

In the subject example, the food product is stored in a package, (container) such as a box or bag made of thin cardboard, paperboard, plastic, laminates, glassines, metal foils, cardboards, thermoplastic films, and/or paper materials that is capable of storing the food product at desired temperatures (e.g., room temperature or freezer temperatures) for a desired amount of time and/or of being heated within a microwave. It is contemplated that other materials capable of storing a food product for the product's shelf life in freezing temperatures and/or room temperatures, and/or capable of being heated within a microwave may be utilized to store the food product without departing from scope and intent of the present disclosure.

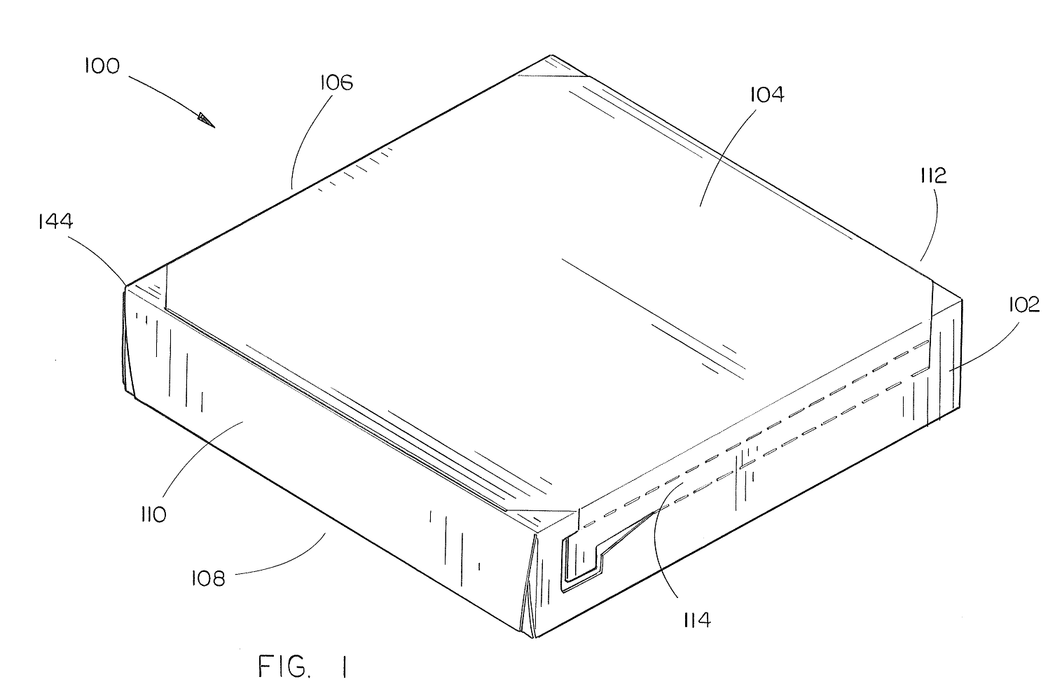

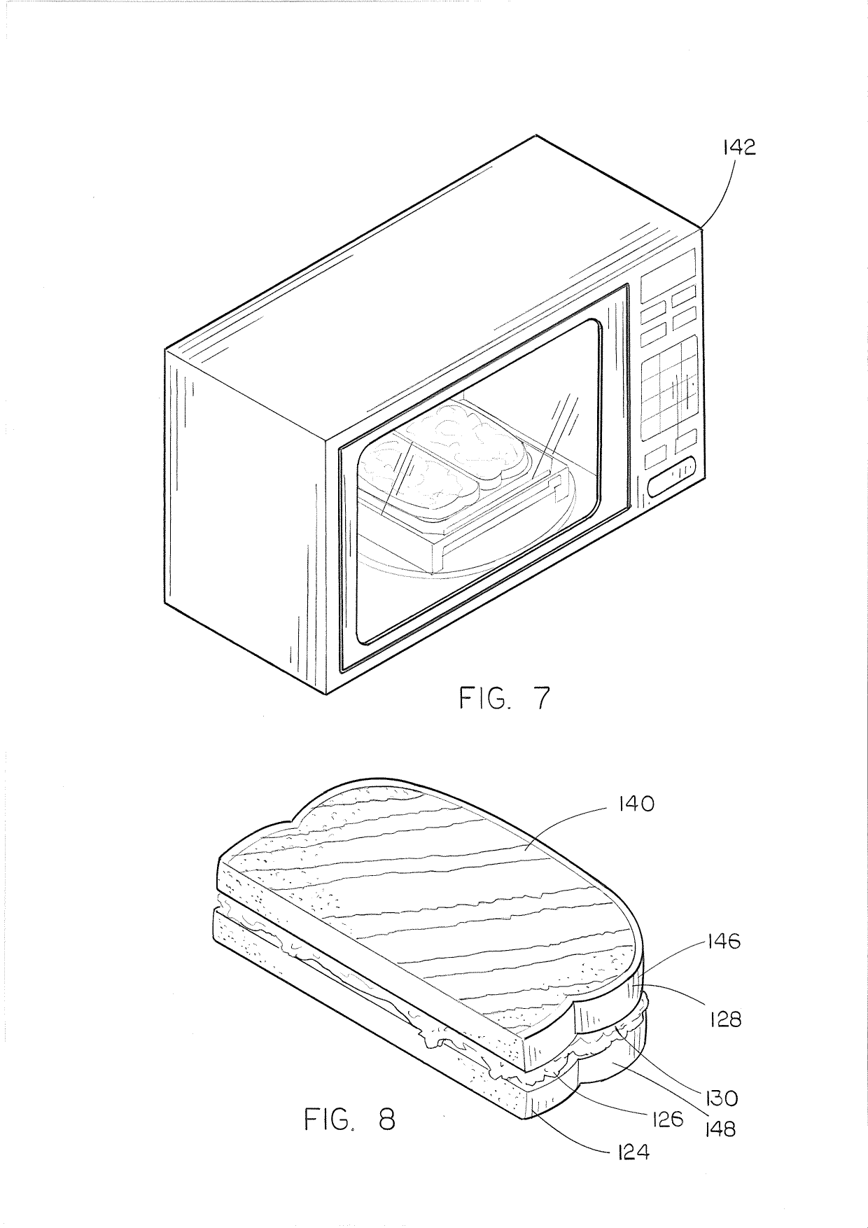

Referring generally to FIGS. 1 through 21, a microwavable food product 100, such as a sandwich, is described. The microwavable food product 100 includes a package, such as a microwavable package 144, a serrated susceptor 120, exterior foodstuffs 146, and interior foodstuffs 126. In one example, the exterior foodstuff is in two pieces 146 and 148, such as two bread products 124 and 128 as illustrated in FIG. 1 through 12. The microwavable food product 100 may also include a plastic bag 122 for keeping the foodstuffs together and undamaged, maintaining flavor, extending the shelf life of the product, and/or preventing freezer burn.

The susceptor 120 of the present disclosure is a thin, flexible sheet including layers of metal, plastic, and/or other materials that when cooked in a microwave become a nonstick heating surface, such as a hot plate. Typically, a metalized plastic film is laminated to a dimensionally stable substrate, such as paper board, by utilizing a conventional adhesive. The metalized plastic film includes a layer of plastic film which is deposited, such as by vacuum deposition, on a layer of metal, such as aluminum. The plastic film may be made from polyethylene terephthalate. While the susceptor has been illustrated and described with some specificity, it will be appreciated that a susceptor may be formed in a different manner and composed of different materials. For example, multiple plastic layers, edible adhesives, embedded patterns in the metalized plastic film, and semi-liquid glossy materials that include glycerine, sucrose ester, and chloride salt may be utilized in the susceptor.

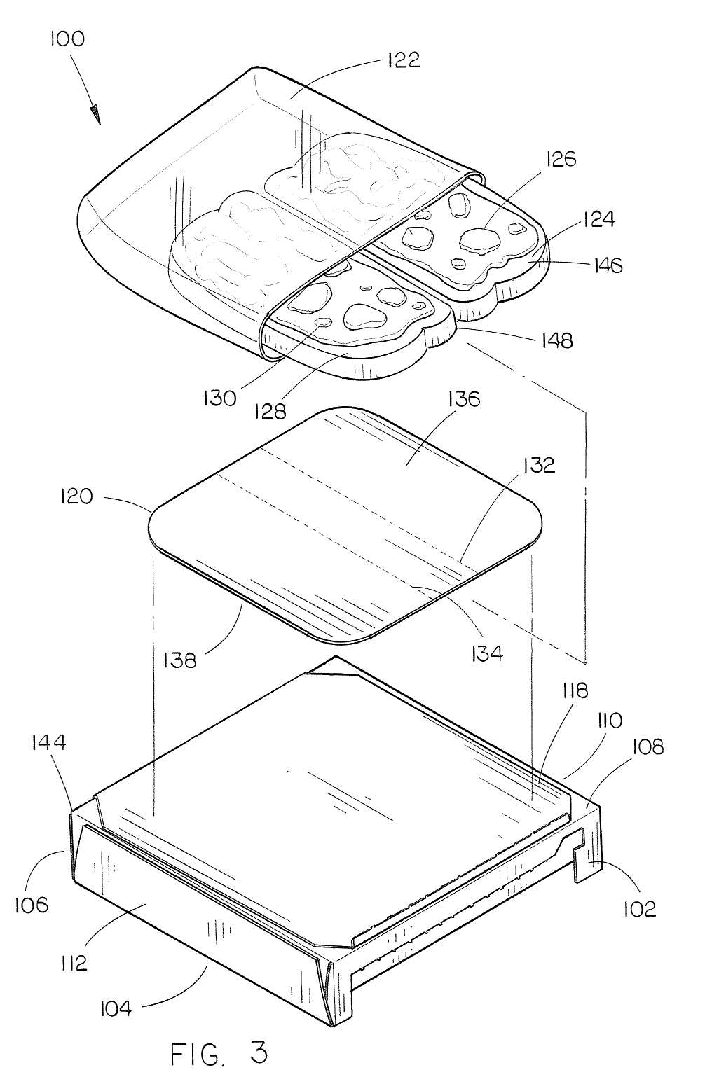

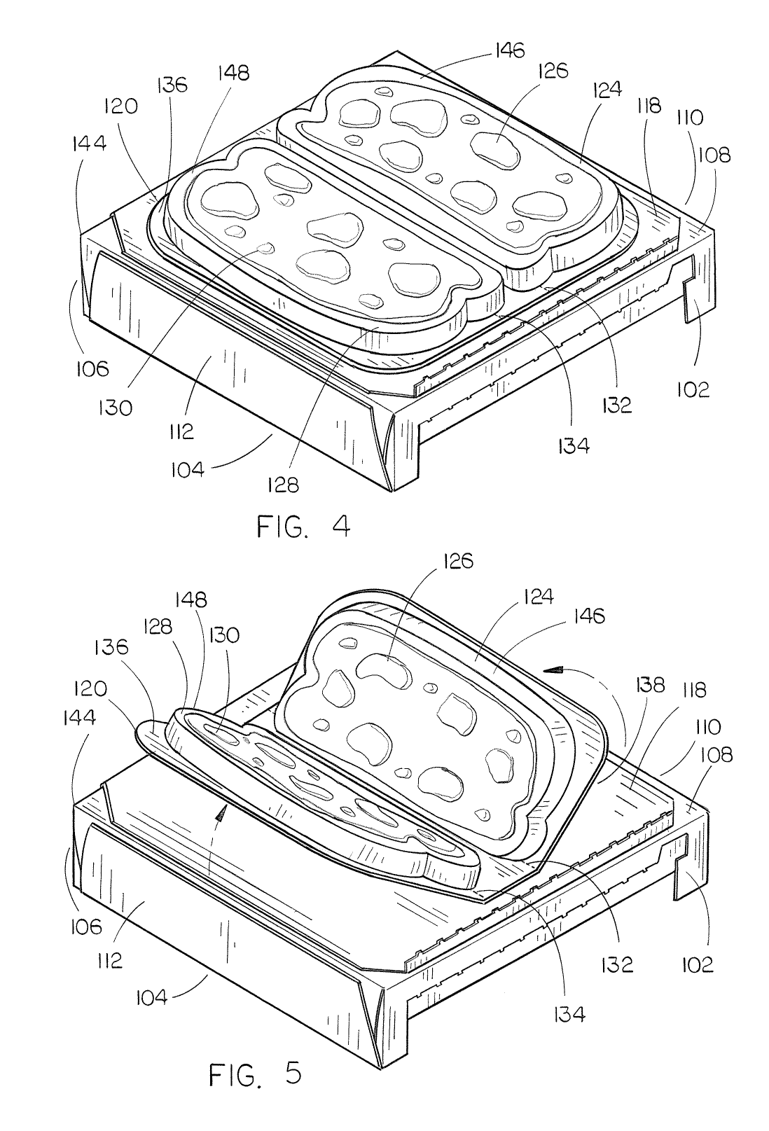

The package 144 has multiple configurations, such as a stored configuration as illustrated in FIG. 1 and an elevated position configuration as illustrated in FIGS. 3 and 4. The package 144 may include a zip-strip 114 on a first wall 102 of the package 144. A zip-strip is a construction where a pair of serrations or perforations may be formed horizontally along the side of the package 144, which may be pulled in a manner ripping a strip from the side wall to open the package 144. However, the opening means of the package 144 of the present disclosure may be located on any side of the package. Moreover, the package 144 may be opened by utilizing a pull string, a zip lock seal, a thumb tab, scissors, a reasonable amount of force, or any other suitable opening means.

The opening left by the zip-strip 114 may then be pulled up on causing a portion of a second wall 104 and a portion of a third wall 106 of the package 144 to partially separate from the package 144 along serrations, along angled cuts already on the package 144, or along weakened areas that extends partially through the thickness of the package 144 to form a partially separated second wall 118. A portion of the third wall 106 separated from the package 144 serves as a hinge 116 allowing the partially separated second wall 118 of the package 144 to be folded around the package 144 to cover a fourth wall 108, which is positioned opposite of the second wall 104 of the package 144. The package 144 is then positioned so that the second wall 104 of the package 144 is adjacent to the countertop or floor of the microwave and the partially separated second wall 118 covering the fourth wall 108 are opposite the second wall 104 to form the elevated position configuration as illustrated in FIGS. 3 and 4 of the package 144. For example, an elevated position configuration includes any package configurable to support a food product during microwave cooking.

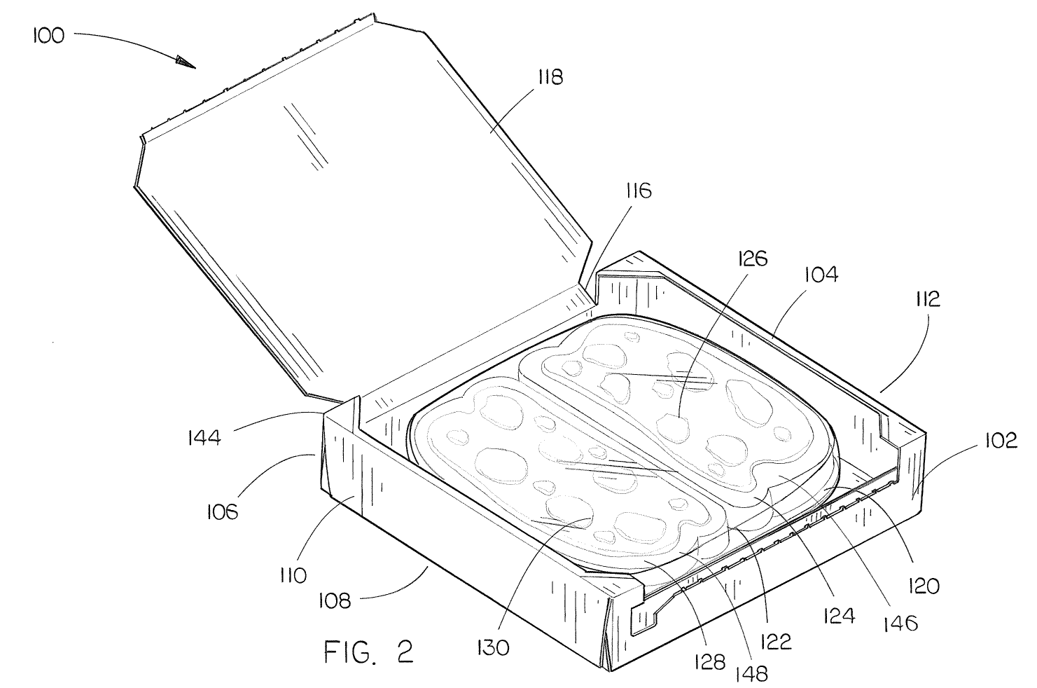

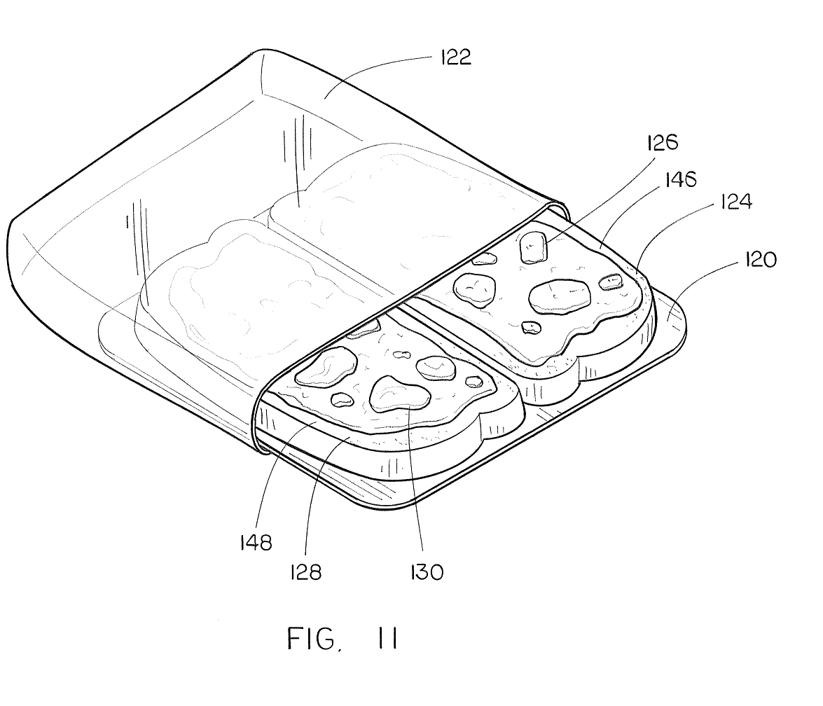

In referring to FIGS. 2 and 3, the items contained within the package 144 are shown. The serrated susceptor 120, exterior foodstuffs 146 and 148, such as two bread products 124, 128, and the interior foodstuffs 126 and 130 are all located inside of the package 144. The package 144 may also contain a plastic bag 122 that may surround the exterior foodstuff 146 and 148 and interior foodstuffs 126 and 130. The plastic bag 122 of the present disclosure may be shrink wrapped, vacuumed packed, air permeable, airtight, sealed, and/or opened. In one example, the plastic bag 122 may be not be utilized at all depending upon the type of package 144 utilized. In another example, the plastic bag 122 may surround the exterior foodstuff 146 and 148, interior foodstuff 126 and 130, and serrated susceptor 120 as illustrated in FIG. 11.

In referring to FIGS. 3, 4, and 7, the assembly of the items for cooking the food product in the microwave is shown. After the package 144 is opened, the plastic bag 122 including the exterior foodstuffs 146 and 148, the interior foodstuff 126 and 130, and the serrated susceptor 120 are removed from the package 144. The package 144 is folded into its elevated position configuration as illustrated in FIGS. 3, 4, and 7. The sealed plastic bag 122 is opened and separated from the exterior foodstuffs 146 and 148, the interior foodstuffs 126 and 130, and the serrated susceptor 120. The package 144 is placed inside the microwave 142. The serrated susceptor 120 is centered on the partially separated second wall 118 of the package 144 in its elevated position configuration as illustrated in FIGS. 3 and 4, with a top side 136 of the serrated susceptor 120 opposite the package 144. In one example, the top side 136 of the serrated susceptor 120 will be configured for indicating to a user that it is the side utilized for cooking. In one example, text, indicia, shininess, or color may indicate the top side 136 of the susceptor 120 to the user. For example, the top side 136 may be the gray, silver, shiny, and/or metalized plastic film side of the susceptor 120 to remind the user of a pan for cooking to indicate that it is the cooking side of the susceptor 120. The top side 136 of the susceptor 120 should always be opposite the package 144, microwave floor, microwave rack, or microwave turntable during cooking. A bottom side 138 of the serrated susceptor 120 is opposite the metalized plastic film or top side 136. The bottom side 138 of the serrated susceptor should be adjacent to the package, the microwave floor, microwave rack, or microwave turntable during cooking.

In one example, two bread products 124, 128 are included in the folded food product. For example, a bread product includes any dough based or bread based leavened or unleavened product. The exterior foodstuffs 146 and 148, such as two bread products 124, 128, are positioned side-by-side with the bottoms of the exterior foodstuff 146 and 148 positioned on the top side 136 of the serrated susceptor 120 supported by the package 144 inside of the microwave 142. For example, side-by-side positioning is when the exterior foodstuffs 146 and 148 are positioned adjacent to each other to substantially mirror each other, wherein the mirror axis is parallel to and centered between the serrations of the serrated susceptor as illustrated in FIG. 4. The interior foodstuff 126 and 130 are positioned on top of the exterior foodstuffs 146 and 148 as illustrated in FIG. 4. The tops of the exterior foodstuffs 146 and 148 are opposite of the serrated susceptor 120. The bottoms of the exterior foodstuffs 146 and 148 are opposite the tops of the exterior foodstuffs 146 and 148 and typically found adjacent to the top side 136 of the susceptor 120. For example, the interior foodstuffs 126 and 130 may include cheeses, meats, vegetables, fruits, omelet product, eggs, bread products, condiments, and/or other folded food product suitable ingredients. The microwave 142 is then closed and the food product is cooked for a desired amount of time. After cooking, the exterior foodstuffs 146 and 148 supporting the interior foodstuffs 126 and 130 are foldable by utilizing the serrated susceptor 120.

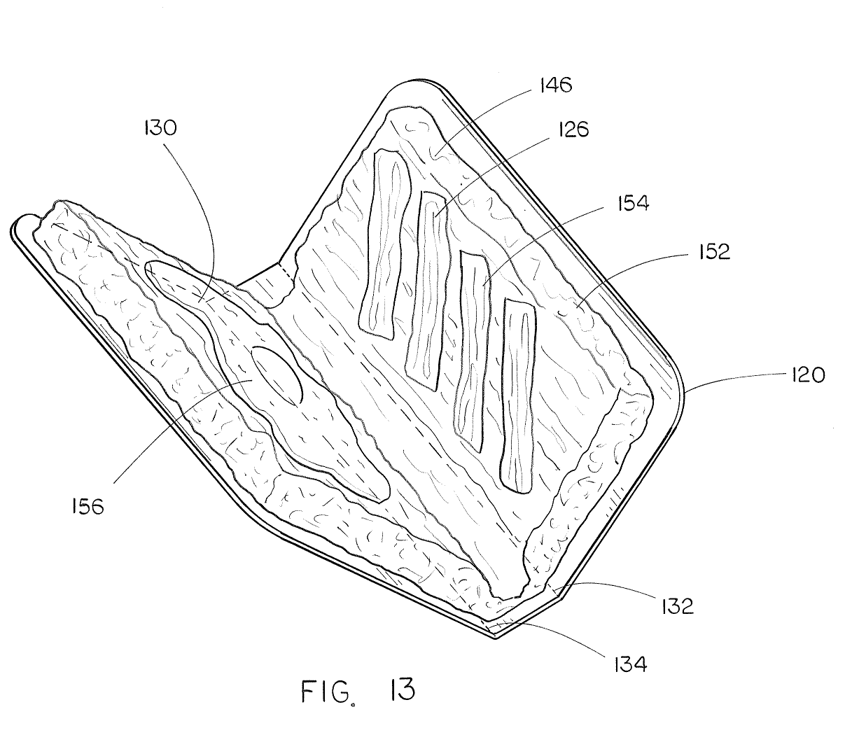

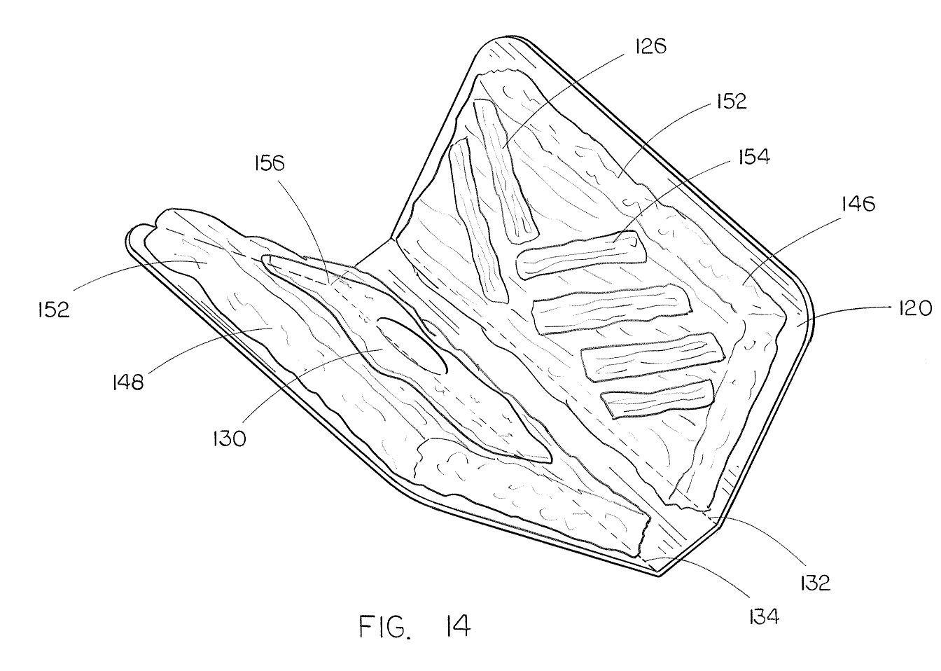

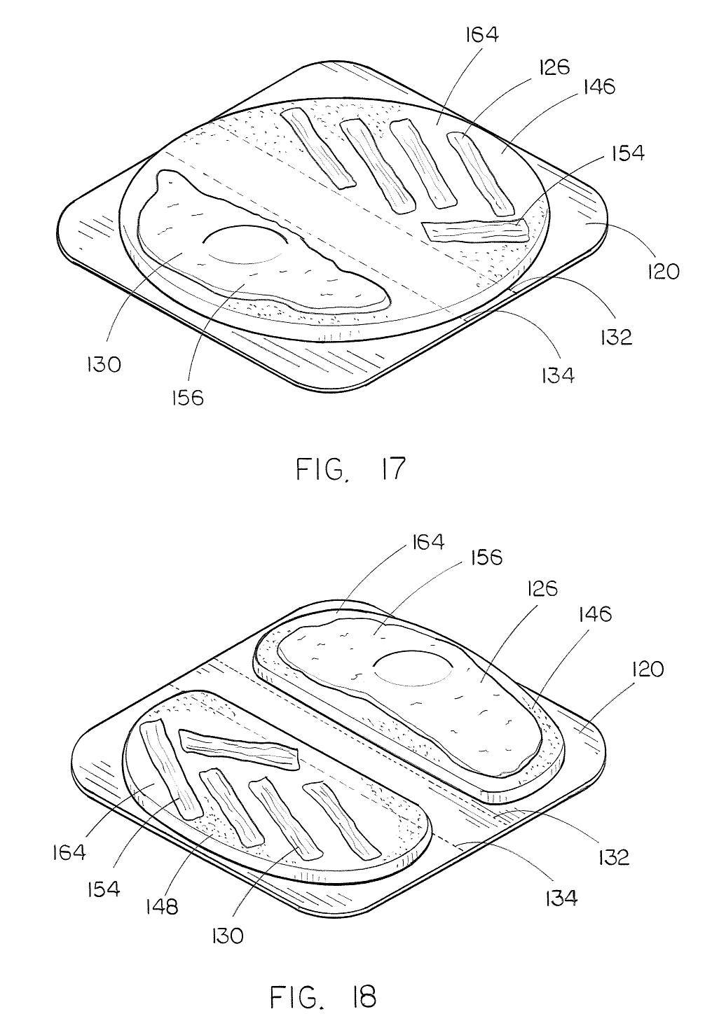

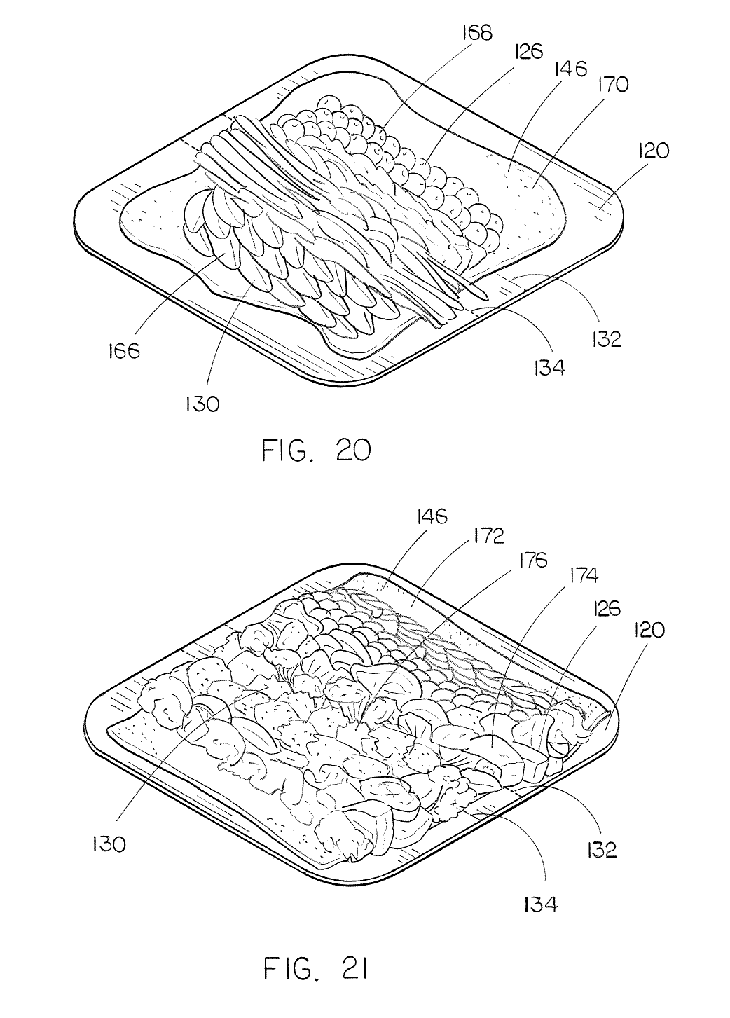

In one example, the exterior foodstuff 146 may be in one continuous piece, as illustrated in FIGS. 13, 15, 17, 20, and 21. In one example, the continuous piece of exterior foodstuff 146 is hash browns 152 as illustrated in FIG. 13 supporting interior foodstuffs 126 and 130, such as bacon 154 and egg 156. In another example, the continuous piece of exterior foodstuff 146 is an omelet product 162, as illustrated in FIG. 15, supporting interior foodstuffs 126 and 130, such as ham 158 and green peppers 160. In a further example, the continuous piece of exterior foodstuff 146 is a pancake 164 as illustrated in FIG. 17 supporting interior foodstuffs 126 and 130, such as egg 156 and bacon 154. In another example, the continuous piece of exterior foodstuff 146 is a crepe 170 as illustrated in FIG. 20 supporting interior foodstuff 126 and 130, such as apples 166 and cherries 168. In a further example, the continuous piece of exterior foodstuff 146 is a pita 172 as illustrated in FIG. 21 supporting interior foodstuff 126 and 130, such as chicken 174 and broccoli 176.

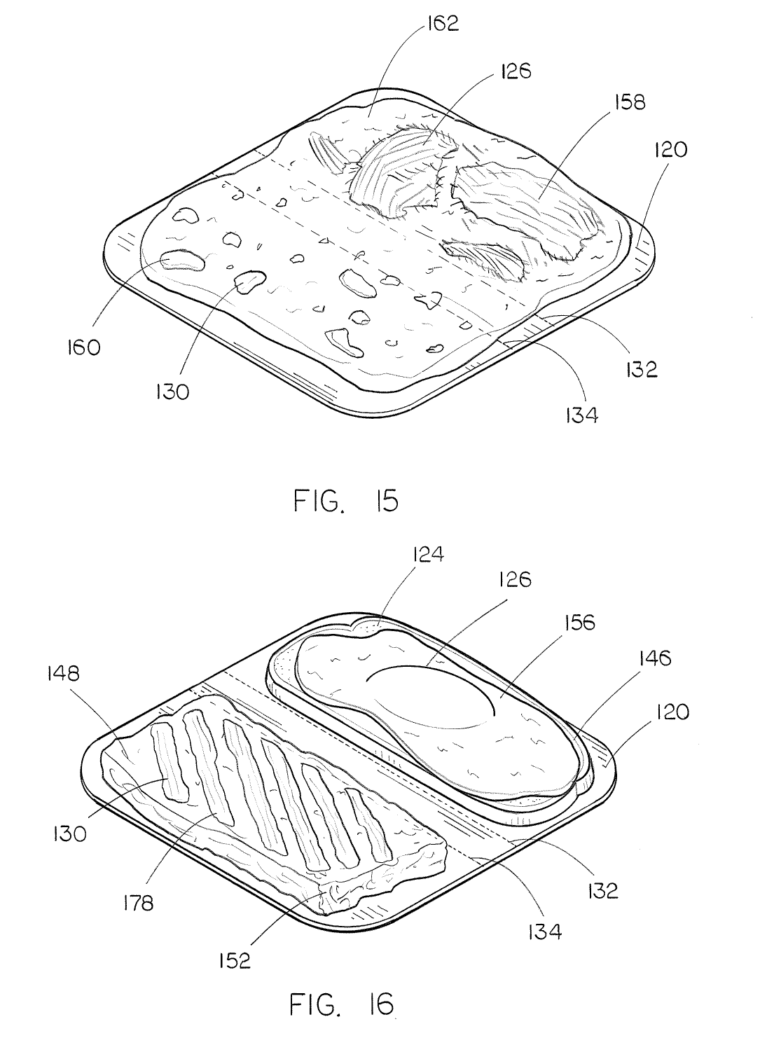

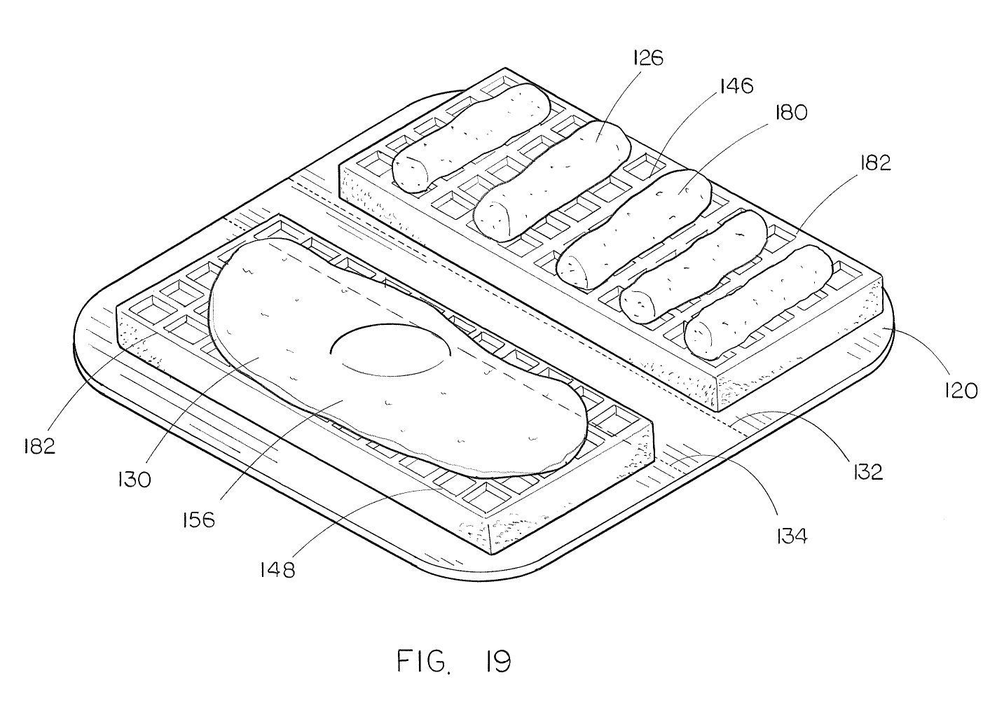

In another example, the exterior foodstuff 146 and 148 may be in two separate pieces, as illustrated in FIGS. 2 through 11, 14, 16, 18, and 19. In one example, the exterior foodstuff 146 and 148 are hash browns 152 as illustrated in FIG. 14 supporting interior foodstuff 126 and 130, such as bacon 154 and egg 156. In another example, the exterior foodstuff 146 and 148 are a bread product 124 and hash browns 152 as illustrated in FIG. 16 supporting interior foodstuff 126 and 130, such as cheese 178 and egg 156. In a further example, the exterior foodstuff 146 and 148 are pancakes 164 as illustrated in FIG. 18 supporting interior foodstuff 126 and 130, such as bacon 154 and egg 156. In another example, the exterior foodstuff 146 and 148 are waffles 182 as illustrated in FIG. 19 supporting interior foodstuff 126 and 130, such as sausage 180 and egg 156.

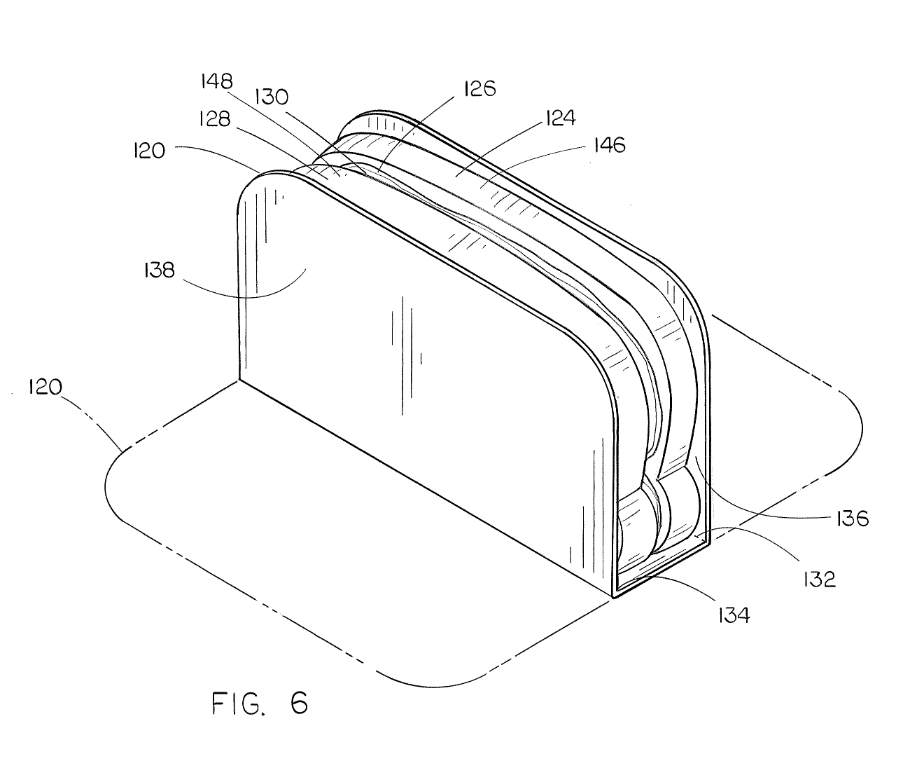

In referring to FIGS. 5 and 6, the utilization of the serrated susceptor 120 for folding is shown. After cooking, the serrated susceptor 120 can be folded up from the package along the two serrations 132 and 134 of the serrated susceptor 120, causing the two open faced halves of the exterior foodstuffs 146 and 148 having interior foodstuff 126 and 130 positioned on the top of the exterior foodstuffs 146 and 148 to be folded together. In one example, the serrations 132 and 134 are placed apart at a distance about equal to the width of the folded food product. In one example, particularly when the folded food product is a sandwich, the serrations 132 and 134 are placed about two inches apart. The bottom side 138 of the serrated susceptor 120 or the side opposite top side 136 may be touched by a consumer without causing undue heating of the hands of a consumer to allow the consumer to fold the hot two open faced halves of the exterior foodstuff 146 and 148 supporting the interior foodstuffs 126 and 130 just after cooking. This folding pushes the interior foodstuffs 126 and 130 on top of the exterior foodstuff 146 and 148 together to form a hot folded food product, such as a sandwich. For example, a sandwich is any food product with at least two sides of an interior foodstuff adjacent to a bread product. Several sandwiches of the present disclosure simulate grilled and/or toasted sandwiches, such as ham and cheese sandwiches and Panini sandwiches. The heated interior food stuffs 126 and 130 may adhere to each other when folded together. Generally, the serrated susceptor 120 mimics a Panini press. The serrated susceptor 120 may be separated from the exterior foodstuffs 146 and 148 before consumption or the serrated susceptor 120 may be utilized as plate/sleeve/pocket for holding the folded food product while eating for on-the-go consumption. In one example, a method for utilizing the susceptor 120 for folding is provided to the consumer in instructions. In one example, the instructions are provided on the package 144.

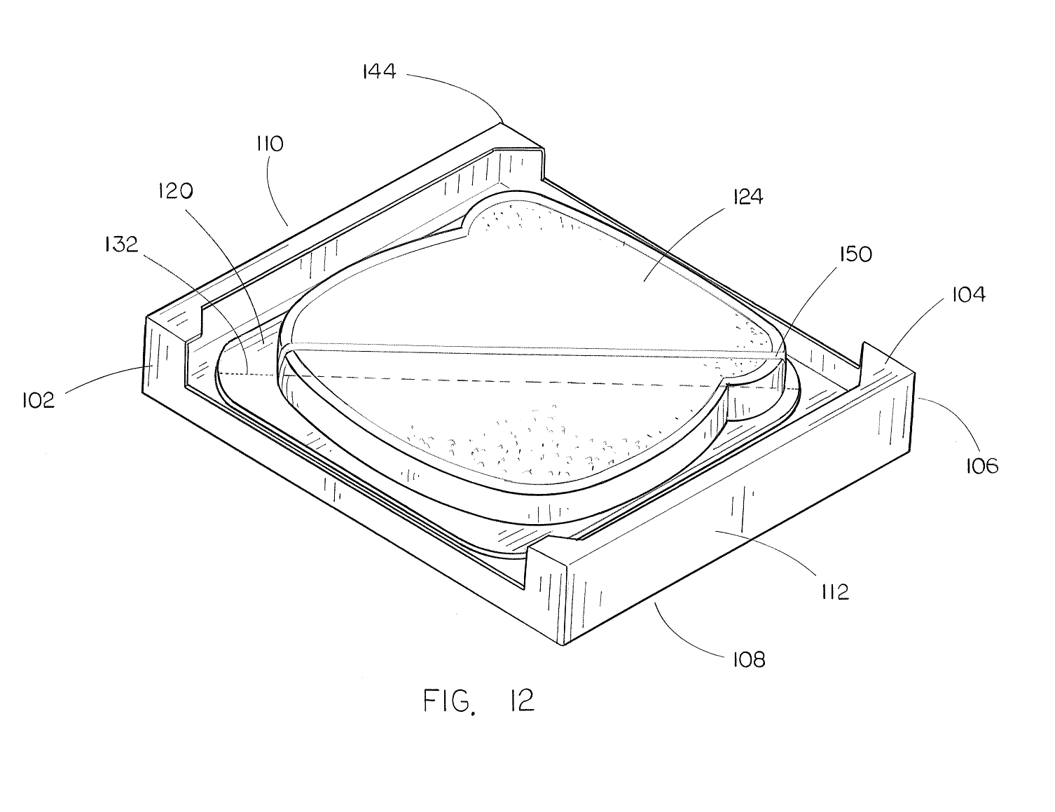

In another example of the present disclosure, only one serration 132 on the susceptor 120 and only one continuous piece of an exterior foodstuff 146, such as a bread product 124, supporting interior foodstuffs 126 may be present, as illustrated in FIG. 12. In one example, the exterior foodstuff 146, such as a bread product 124, is partially cut, 150, as illustrated in FIG. 12. In another example, the bread product 124 is serrated. For example, the bread product is positioned on top of the serrated susceptor so that serration or partial cut of the bread product 124 aligns generally over the serration 132 of the susceptor 120, as illustrated in FIG. 12. After cooking, the susceptor 120 is folded up from the package 144, the floor of the microwave, the microwave rack, or the microwave turntable along its serration to form a folded food product, such as sandwich.

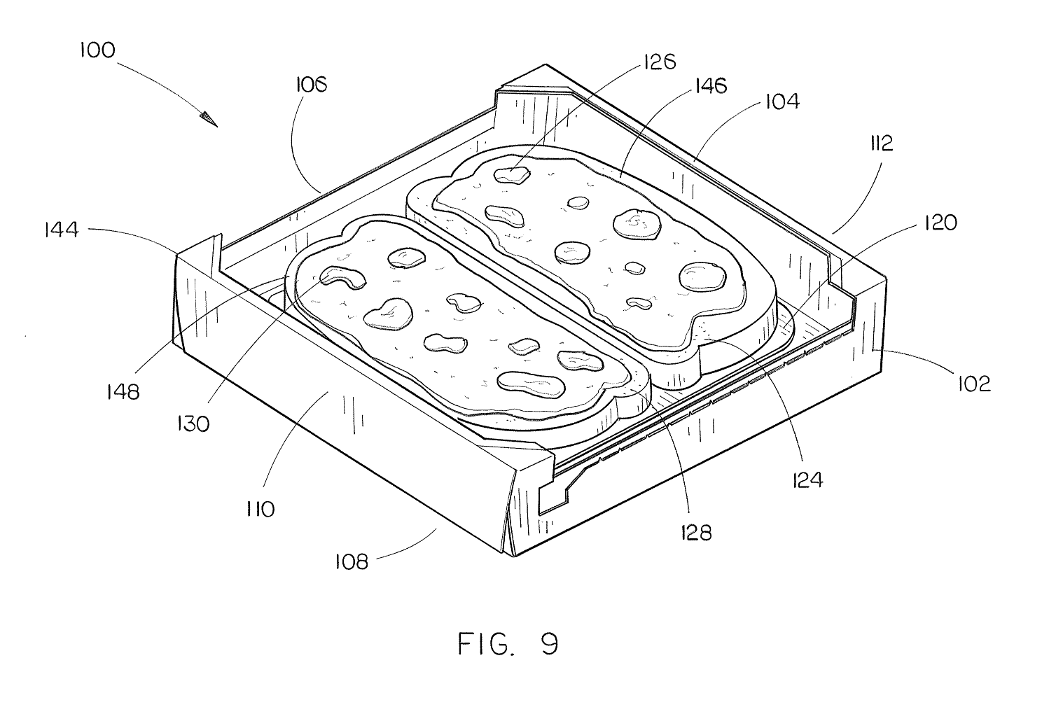

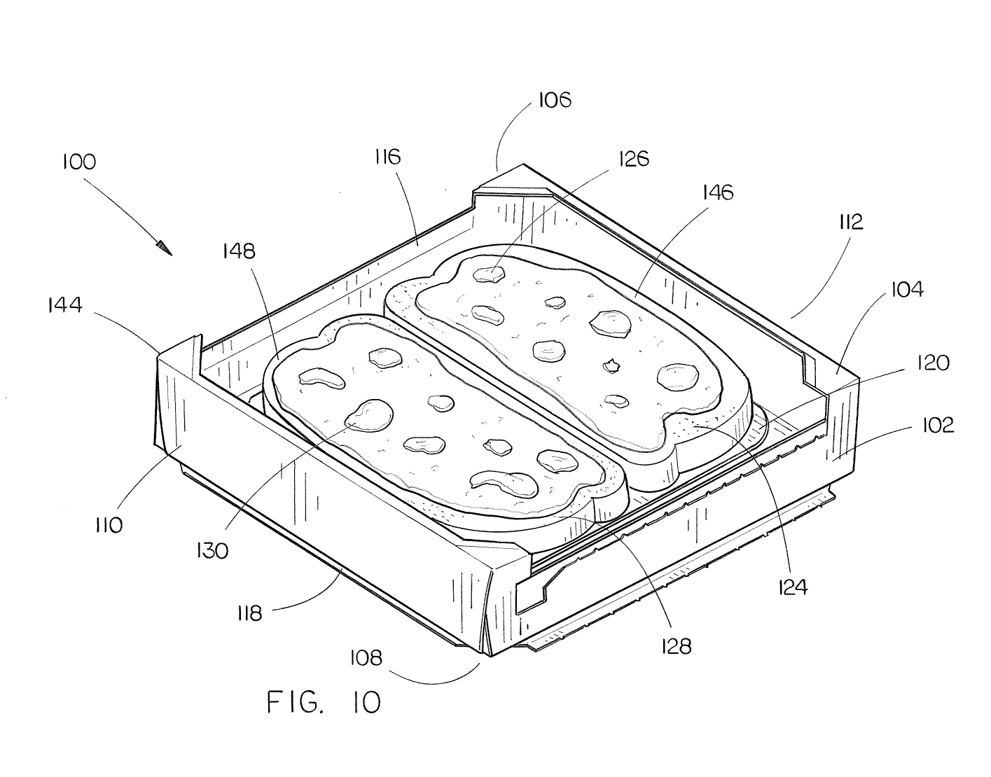

While the package 144 has been illustrated and described with some specificity, it will be appreciated that the serrated susceptor 120, exterior foodstuff 146 and 148, interior foodstuff 126 and 130, and plastic bag 122 could be packaged differently. For example, these components may be included as part of a microwave meal kit including a cup of soup, dessert, and/or separate vegetable. Moreover, the serrated susceptor 120 may be placed directly on the floor of the microwave, the microwave turntable, or on a microwave rack without the utilization of the package 144. Furthermore, in another example of the elevated cooking configuration, the package 144 may be folded in a different manner to produce a different package configuration, such as when the food product and the serrated susceptor 120 are placed inside a package in a recessed package configuration as illustrated in FIG. 9 or a folded recessed package configuration as illustrated in FIG. 10 for microwave cooking. It is understood that any suitable microwavable cooking configuration of the package may be utilized without departing from the scope and intent of the present disclosure.

In a further example, browning agents are applied to the bottom of a food product to produce the appearance of grilling or toasting of the food product after heating the bottom (the side adjacent to the top side 136 of the serrated susceptor 120) of the food product on the serrated susceptor 120 in the microwave. In one example, a browning agent is applied to the bottom of the bread product prior to cooking and typically during production. For example, browning agents useful for present disclosure produce coloring through the burning of sugars. A browning agent (a certain type of sugar derivative) is added to a product by spraying or stamping, brushing, dipping, coating, and/or any other suitable application means. While cooking, a browning agent, such as Maillose, will undergo a reaction, which creates a natural golden and/or baked coloring. The color produced by browning agents is very stable and inert. Moreover, browning agents add substantially no taste to a product. In one example, the browning agent is fat free.

In referring to FIG. 8, the browning agent may be applied using a stamp to form parallel diagonal lines of the browning agent across the bottom of the bread product or the side adjacent to the susceptor 120. After heating the bottom of the bread product on the serrated susceptor 120 in the microwave, the parallel diagonal lines of the browning agent brown to create the appearance of grill marks 140 as illustrated in FIG. 8. Browning agents may also be applied in other patterns to give the appearance of other types of cooking including toasting and frying and fun shapes, such as smiley faces. For example, the browning agent may form indicia, logos, shapes (i.e. triangles), checker patterns, irregular patterns, text, prize notifications, animals, characters, polka dots, and other simple or more complicated patterns. The desired browning patterns form correctly over 90% of the time after microwave cooking when browning agents are utilized. In the past, patterned susceptors were utilized to create specific browning patterns; however, patterned susceptors only produced the desired browning pattern about 50 percent of the time. Consequently, the utilization of browning agents is more consistent and reliable than the utilization of patterned susceptors to form desired browning patterns.

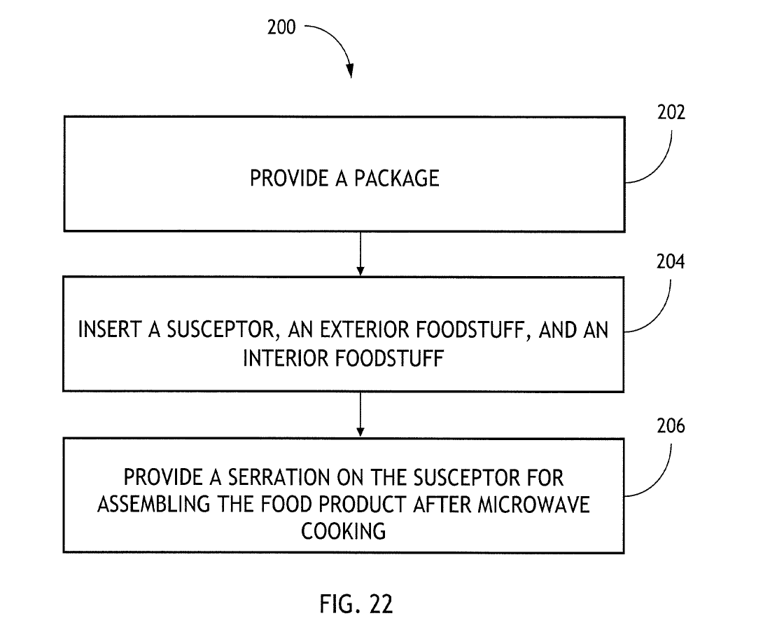

Referring generally to FIG. 22, a method for providing a food product assembled after microwave cooking 200 is described. A package is provided, 202. In one example, the package may be configurable into an elevated position. A susceptor, an exterior foodstuff, and an interior foodstuff are inserted into the package, 204. The exterior foodstuff may include at least one of eggs, omelet product, vegetables, bread products, pancakes, waffles, French toast, tortillas, pitas, and meat. The interior foodstuff may include at least one of meat, cheeses, fruits, vegetables, bread products, omelet product, eggs, condiments, and the like. In one example, the interior foodstuff is supported by the exterior foodstuff. In another example, a browning agent is applied to the exterior foodstuff. In a further example, a serration is provided on the exterior foodstuff. A serration is provided on the susceptor, 206. The susceptor and the serration are utilized for assembling the food product after microwave cooking.

In exemplary embodiments of the disclosure, the methods disclosed may be implemented as sets of instructions, through a single production device, and/or through multiple production devices. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present disclosure. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components thereof without departing from the scope and spirit of the disclosure or without sacrificing all of its material advantages. The form herein before described being merely an explanatory embodiment thereof, it is the intention of the following claims to encompass and include such changes.

What is claimed is:

1. A microwavable food product comprising:
a susceptor;
a foodstuff positioned on the susceptor in an open-faced configuration; and
the susceptor including at least one fold positioned at an intermediate region of the foodstuff for allowing the foodstuff to be folded from the open-faced configuration to a closed-faced configuration.

2. A microwavable food product as claimed in claim 1, wherein the susceptor includes a first fold and a second fold.

3. A microwavable food product as claimed in claim 2, wherein a distance defined between the first and second folds of the susceptor is about equal to a width of a folded foodstuff formed by the folding of the foodstuff to the closed-faced configuration.

4. A microwavable food product as claimed in claim 1, wherein the foodstuff includes a first piece of bread and a second piece of bread.

5. A microwavable food product as claimed in claim 4, wherein the foodstuff includes an interior foodstuff position at a top surface of the first piece of bread and the second piece of bread.

6. A microwavable food product as claimed in claim 1, wherein the fold is a serration.

7. A microwavable food product as claimed in claim 1, further comprising a package having a stored configuration in which the susceptor and the foodstuff are disposed and an elevated position configuration that is adapted to support the susceptor and the foodstuff during cooking.

8. A microwavable food product as claimed in claim 7, further comprising an enclosure disposed in the package in the stored configuration, wherein the susceptor and the foodstuff are disposed in the enclosure.

9. A microwavable food product as claimed in claim 1, further comprising a browning agent disposed on a surface of the foodstuff adjacent to the susceptor.

10. A microwavable food product as claimed in claim 9, wherein the browning agent is a sugar derivative.

11. A microwave food product as claimed in claim 9, wherein the browning agent forms diagonal lines across the surface of the foodstuff.

12. A microwavable food product comprising:
a susceptor having a top side and a bottom side;
an exterior foodstuff positioned on the top side of the susceptor, the exterior foodstuff including a first half-portion and a second half-portion, the first half-portion and the second half-portion having top surfaces and bottom surfaces, wherein the bottom surfaces are adjacent to the top side of the susceptor;
an interior foodstuff positioned at the top surfaces of the first and second half-portions of the exterior foodstuff; and
wherein the susceptor includes a first and second fold line positioned adjacent a mid-region of the exterior foodstuff for allowing the exterior foodstuff to be folded in half such that the interior foodstuff on the first half-portion is brought into contact with the interior foodstuff on the second half-portion.

13. A microwavable food product as claimed in claim 12, further comprising a package having a stored configuration in which the susceptor, the exterior foodstuff, and the interior foodstuff are disposed.

14. A microwavable food product as claimed in claim 13, wherein the package includes an elevated position configuration that is adapted to support the susceptor, the exterior foodstuff, and the interior foodstuff during cooking.

15. A microwavable food product as claimed in claim 13, further comprising an enclosure disposed in the package in the stored configuration, wherein the susceptor, the exterior foodstuff, and the interior foodstuff are disposed in the enclosure.

16. A microwavable food product as claimed in claim 15, further comprising a browning agent disposed on the bottom surfaces of the first and second half-portions.

17. A microwavable food product as claimed in claim 16, wherein the browning agent forms diagonal lines across the bottom surfaces of the first and second half-portions.

18. A method for assembling a microwavable food product, the method comprising:
providing a package;
inserting a susceptor-foodstuff assembly into the package, wherein the susceptor food assembly includes a susceptor having a top side, a first and second portion of an exterior foodstuff having bottom surfaces adjacent to the top side of the susceptor, and an interior foodstuff positioned at a top side of the exterior foodstuff; and
providing a fold line on the susceptor for folding the exterior foodstuff after cooking such that the interior foodstuff on the first portion of the exterior foodstuff comes into contact with the interior foodstuff on the second portion of the exterior foodstuff.

19. A method for assembling a microwavable food product as claimed in claim 18, wherein the susceptor includes a first fold line and a second line positioned adjacent a mid-region of the exterior foodstuff.

20. A method for assembling a microwavable food product as claimed in claim 19, wherein a distance defined between the first and second fold lines of the susceptor is about equal to a width of a folded foodstuff formed by the folding of the exterior foodstuff and the interior foodstuff.
